(19) United States
(12) Patent Application Publication
(10) Pub. No.: US 2024/0208058 A1
(43) Pub. Date: Jun. 27, 2024

(54) METHODS AND APPARATUS FOR AUTOMATED CEILING DETECTION

(71) Applicant: Boston Dynamics, Inc., Waltham, MA (US)

(72) Inventors: Lukas Merkle, Cambridge, MA (US); Matthew Turpin, Newton, MA (US); Logan Tutt, Boston, MA (US)

(73) Assignee: Boston Dynamics, Inc., Waltham, MA (US)

(21) Appl. No.: 18/545,050

(22) Filed: Dec. 19, 2023

Related U.S. Application Data
(60) Provisional application No. 63/434,505, filed on Dec. 22, 2022.

(51) Int. Cl. B25J 9/16; G01S 13/88; G05D 1/648

(52) U.S. Cl. CPC B25J 9/1664; G01S 13/881; G05D 1/6484

(57) ABSTRACT

Methods and apparatus for estimating a ceiling location of a container within which a mobile robot is configured to operate are provided. The method comprises sensing distance measurement data associated with the ceiling of the container using one or more distance sensors arranged on an end effector of a mobile robot, and determining a ceiling estimate of the container based on the distance measurement data.

### CROSS-REFERENCE TO RELATED APPLICATIONS

This application claims the benefit under 35 U.S.C. § 119(e) to U.S. Provisional Patent Application No. 63/434,505, filed Dec. 22, 2022, and titled “METHODS AND APPARATUS FOR AUTOMATED CEILING DETECTION,” the entire contents of which is incorporated by reference herein.

### FIELD OF THE INVENTION

This disclosure relates to techniques for automated ceiling detection by a robotic device.

### BACKGROUND

A robot is generally defined as a reprogrammable and multifunctional manipulator designed to move material, parts, tools, and/or specialized devices (e.g., via variable programmed motions) for performing tasks. Robots may include manipulators that are physically anchored (e.g., industrial robotic arms), mobile devices that move throughout an environment (e.g., using legs, wheels, or traction-based mechanisms), or some combination of one or more manipulators and one or more mobile devices. Robots are currently used in a variety of industries, including, for example, manufacturing, warehouse logistics, transportation, hazardous environments, exploration, and healthcare.

### SUMMARY

Mobile robots may be tasked with operating inside containers that have ceilings, such as truck cargo compartments or shipping containers. To avoid damage to the robot and/or the container, the robot should be aware of the location and/or geometry of the ceiling of the container within which it is operating. Some embodiments of the present disclosure relate to automated techniques for estimating one or more characteristics of the ceiling of the container (e.g., height, geometry, etc.), such that the robot can be controlled to operate safely within the container.

In one aspect, the invention features a method of estimating a ceiling location of a container within which a mobile robot is configured to operate. The method includes sensing distance measurement data associated with the ceiling of the container using one or more distance sensors arranged on an end effector of a mobile robot, and determining a ceiling estimate of the container based on the distance measurement data.

In some embodiments, the one or more distance sensors include a first distance sensor arranged on a first side of the end effector, the first distance sensor being configured to sense a first distance in a first direction. The method further comprises orienting, prior to sensing the distance measurement data, the first distance sensor such that the first direction is toward the ceiling of the container. In some embodiments, the one or more distance sensors include a second distance sensor arranged on a second side of the end effector, the second distance sensor being configured to sense a second distance in a second direction, the second direction being opposite the first direction, and sensing distance measurement data comprises sensing distance measurement data including the first distance and the second distance.

In some embodiments, sensing distance measurement data comprises controlling an arm of the mobile robot to move the arm through a scan trajectory, and sensing the distance measurement data as the arm is moved through the scan trajectory. In some embodiments, controlling an arm of the mobile robot to move the arm through a scan trajectory comprises moving the arm through a scan trajectory that includes a first direction and a second direction at an angle to the first direction. In some embodiments, the scan trajectory includes a first segment along the first direction, a second segment along the first direction, and a third segment along the second direction, the third segment connecting the first and second segments. In some embodiments, sensing distance measurement data is performed while a base of the mobile robot is outside of the container.

In some embodiments, determining a ceiling estimate based on the distance measurement data comprises fitting a plane based on at least one datum in the distance measurement data, and determining the ceiling estimate based on the plane. In some embodiments, determining a ceiling estimate based on the distance measurement data further comprises determining the at least one datum as a datum having a minimum distance in the distance measurement data. In some embodiments, determining a ceiling estimate based on the distance measurement data further comprises filtering the distance measurement data to generate filtered distance measurement data, and determining the ceiling estimate based on the filtered distance measurement data. In some embodiments, filtering the distance measurement data comprises sorting the distance measurement data in order of distance to generate sorted data, and excluding from the filtered distance measurement data, a threshold amount of the sorted data with the smallest distances.

In some embodiments, fitting a plane comprises fitting a flat plane to the at least one datum. In some embodiments, the flat plane is parallel to a floor of the container. In some embodiments, the flat plane is sloped relative to a floor of the container. In some embodiments, fitting a plane comprises fitting a curved plane using at least two pieces of data of the distance measurement data.

In some embodiments, determining a ceiling estimate based on the distance measurement data further comprises assigning a shape primitive to the plane, and controlling at least one operation of the mobile robot based, at least in part, on the shape primitive.

In some embodiments, the method further includes controlling at least one operation of the mobile robot based on the ceiling estimate of the container. In some embodiments, controlling at least one operation of the mobile robot based on the ceiling estimate of the container comprises determining a trajectory of an arm of the mobile robot based, at least in part, on the ceiling estimate, and moving the arm in accordance with the trajectory. In some embodiments, controlling at least one operation of the mobile robot based on the ceiling estimate of the container comprises determining a grasp strategy for grasping an object in the container based, at least in part, on the ceiling estimate, and grasping the object using the grasp strategy. In some embodiments, controlling at least one operation of the mobile robot based on the ceiling estimate of the container comprises controlling the mobile robot to move at least one component of the mobile robot without colliding with the ceiling of the container.

In some embodiments, the container comprises a truck cargo compartment. In some embodiments, the container comprises a shipping container. In some embodiments, the end effector comprises a suction-based gripper. In some embodiments, the one or more distance sensors include one or more time-of-flight point sensors.

In one aspect, the invention features a mobile robot. The mobile robot includes a mobile base, an arm coupled to the mobile base, a gripper coupled to the arm, wherein the gripper includes one or more distance sensors arranged thereon, and a controller. The controller is configured to determine a ceiling estimate of a container based on distance measurement data sensed by the one or more distance sensors.

In some embodiments, the one or more distance sensors include a first distance sensor arranged on a first side of the gripper, the first distance sensor being configured to sense a first distance in a first direction, and the controller is further configured to orient, prior to sensing the distance measurement data, the first distance sensor such that the first direction is toward the ceiling of the container. In some embodiments, the one or more distance sensors include a second distance sensor arranged on a second side of the gripper, the second distance sensor being configured to sense a second distance in a second direction, the second direction being opposite the first direction, and the distance measurement data includes distance measurement data sensed by the first distance sensor and the second distance sensor.

In some embodiments, the controller is further configured to control the arm of the mobile robot to move the arm through a scan trajectory when the first distance sensor is oriented toward the ceiling of the container. In some embodiments, controlling the arm of the mobile robot to move the arm through a scan trajectory comprises controlling the arm to move through a scan trajectory that includes a first direction and a second direction at an angle to the first direction. In some embodiments, the scan trajectory includes a first segment along the first direction, a second segment along the first direction, and a third segment along the second direction, the third segment connecting the first and second segments. In some embodiments, the distance measurement data is sensed while the mobile base of the mobile robot is outside of the container.

In some embodiments, determining a ceiling estimate of the container based on the distance measurement data comprises fitting a plane based on at least one datum in the distance measurement data, and determining the ceiling estimate of the container based on the plane. In some embodiments, determining a ceiling estimate of the container based on the distance measurement data further comprises determining the at least one datum as a datum having a minimum distance in the distance measurement data. In some embodiments, determining a ceiling estimate of the container based on the distance measurement data further comprises filtering the distance measurement data to generate filtered distance measurement data, and determining the ceiling estimate of the container based on the filtered distance measurement data. In some embodiments, filtering the distance measurement data comprises sorting the distance measurement data in order of distance to generate sorted data, and excluding from the filtered distance measurement data, a threshold amount of the sorted data with the smallest distances.

In some embodiments, fitting a plane comprises fitting a flat plane to the at least one datum. In some embodiments, the flat plane is parallel to a floor of the container. In some embodiments, the flat plane is sloped relative to a floor of the container. In some embodiments, fitting a plane comprises fitting a curved plane using at least two pieces of data of the distance measurement data.

In some embodiments, determining a ceiling estimate of the container based on the distance measurement data further comprises assigning a shape primitive to the plane, and controlling an operation of the mobile robot based, at least in part, on the shape primitive.

In some embodiments, the controller is further configured to control an operation of the mobile robot based, at least in part, on the ceiling estimate. In some embodiments, controlling an operation of the mobile robot based on the ceiling estimate comprises determining a trajectory of the arm of the mobile robot based, at least in part, on the ceiling estimate, and moving the arm in accordance with the trajectory. In some embodiments, controlling an operation of the mobile robot based on the ceiling estimate comprises determining a grasp strategy for grasping an object in the container based, at least in part, on the ceiling estimate, and grasping the object using the grasp strategy. In some embodiments, controlling an operation of the mobile robot based on the ceiling estimate comprises controlling the mobile robot to move at least one component of the mobile robot without colliding with the ceiling of the container.

In some embodiments, the container comprises a truck cargo compartment. In some embodiments, the container comprises a shipping container. In some embodiments, the gripper comprises a suction-based gripper. In some embodiments, the one or more distance sensors include one or more time-of-flight point sensors.

In one aspect, the invention features a component of a mobile robot. The component includes an arm configured to couple to a base of the mobile robot, and an end effector coupled to the arm, the end effector including one or more distance sensors. The arm is configured to move through a scan trajectory. The end effector is configured to orient a first distance sensor of the one or more distance sensors toward a ceiling of a container. The first distance sensor is configured to capture first distance measurements as the arm is moved through the scan trajectory. A ceiling height of the container is determined based, at least in part, on the plurality of distance measurements.

In some embodiments, the first distance sensor is arranged on a first side of the end effector. In some embodiments, the one or more distance sensors include a second distance sensor arranged on a second side of the end effector opposite the first side, the second distance sensor being configured to sense second distance measurements as the arm is moved through the scan trajectory, and the ceiling height of the container is determined based, at least in part, on the first distance measurements and the second distance measurements.

In some embodiments, the scan trajectory includes a first direction and a second direction at an angle to the first direction. In some embodiments, the scan trajectory includes a first segment along the first direction, a second segment along the first direction, and a third segment along the second direction, the third segment connecting the first and second segments. In some embodiments, the first distance sensor is configured to capture the first plurality of distance measurements while the base of the mobile robot is outside of the container.

In some embodiments, the container comprises a truck cargo compartment. In some embodiments, the container comprises a shipping container. In some embodiments, the end effector is a gripper. In some embodiments, the gripper comprises a suction-based gripper. In some embodiments, the one or more distance sensors include one or more time-of-flight point sensors.

### BRIEF DESCRIPTION OF DRAWINGS

The advantages of the invention, together with further advantages, may be better understood by referring to the following description taken in conjunction with the accompanying drawings. The drawings are not necessarily to scale, and emphasis is instead generally placed upon illustrating the principles of the invention.

FIGS. 1A and 1B are perspective views of a robot, according to an illustrative embodiment of the invention.

FIG. 2A depicts robots performing different tasks within a warehouse environment, according to an illustrative embodiment of the invention.

FIG. 2B depicts a robot unloading boxes from a truck and placing them on a conveyor belt, according to an illustrative embodiment of the invention.

FIG. 2C depicts a robot performing an order building task in which the robot places boxes onto a pallet, according to an illustrative embodiment of the invention.

FIG. 3 is a perspective view of a robot, according to an illustrative embodiment of the invention.

FIGS. 4A and 4B are example color camera images of an interior of a container within which a robotic device is operating.

FIG. 5 is a schematic of an end effector of a robotic device that includes a plurality of distance sensors used to detect a ceiling of a container, according to an illustrative embodiment of the invention.

FIG. 6 is a flowchart of a process for detecting a ceiling estimate of a container using distance measurements sensed using one or more distance sensors arranged on an end effector of a robotic device, according to an illustrative embodiment of the invention.

FIG. 7 is a flowchart of a process for sensing distance measurements while moving an arm of a robotic device through a scan trajectory, according to an illustrative embodiments of the invention.

FIG. 8 schematically illustrates a process for sensing a distance measurement using a distance sensor arranged on an end effector of a robotic device, according to an illustrative embodiment of the invention.

FIG. 9 schematically illustrates a scan trajectory used to obtain distance measurements of a ceiling of a container, according to an illustrative embodiment of the invention.

FIG. 10 is a flowchart of a process for determining a ceiling estimate based on distance measurements sensed using a distance sensor arranged on an end effector of a robotic device, according to an illustrative embodiment of the invention.

FIGS. 11A-11C schematically illustrate different scenarios of containers having non-flat ceiling geometries, which may be detected and modeled, according to illustrative embodiments of the invention.

FIG. 12 illustrates an example configuration of a robotic device, according to an illustrative embodiment of the invention.

### DETAILED DESCRIPTION

To operate safely in an environment, a mobile manipulator robot should be aware of characteristics of the environment within which it is operating and plan its movements appropriately to prevent damage to the robot or objects in the environment. One such environment in which mobile robots may operate is a container, such as a truck cargo compartment, that includes walls, a floor, and a ceiling. To ensure that the robot does not collide with the walls or the ceiling during operation (e.g., a “pick and place” operation described below), the robot may arrange its position inside of the container and plan its movements appropriately by selecting trajectories that do not contact these surfaces. Determining a reliable estimate of the position of the walls and ceiling of the container relative to the robot is important to ensure that the movements of the robot are constrained sufficiently to avoid damage to the robot and/or the container but not too constrained to unnecessarily limit the workspace and/or operation of the robot within the container, which may slow down operation of the robot.

Measuring the location of the walls of the container with suitable accuracy after the robot has entered the container is typically accomplished with reasonable accuracy using distance sensors (e.g., scanning LIDAR sensors) mounted on the base of the mobile robot. Such distance sensors may also be used, among other things, for robot navigation and obstacle avoidance. The inventors have recognized, however, that determining a reasonable estimate of the location and/or shape of the ceiling of a container is considerably more challenging. For instance, ceilings in containers are often reflective, which may limit the ability of color (e.g., RGB) cameras that are typically used for object detection/recognition to also accurately detect the ceiling. Due to the challenge with accurately measuring characteristics of the ceiling using existing sensors on the robot, ceiling height of a container may be measured manually by a human prior to the robot entering the container, and the measured ceiling height may be entered by the human operator into a user interface to inform a controller of the robot how to plan and execute its movements accordingly. Manual measurement of the ceiling height by a human operator is time-consuming, error prone, and doesn't account for variations in the ceiling geometry unless multiple measurements are made at different locations within the container. Some embodiments of the present disclosure relate to an automated technique for detecting the ceiling of a container using one or more distance sensors mounted on an end effector of a mobile robot.

Robots can be configured to perform a number of tasks in an environment in which they are placed. Exemplary tasks may include interacting with objects and/or elements of the environment. Notably, robots are becoming popular in warehouse and logistics operations. Before robots were introduced to such spaces, many operations were performed manually. For example, a person might manually unload boxes from a truck onto one end of a conveyor belt, and a second person at the opposite end of the conveyor belt might organize those boxes onto a pallet. The pallet might then be picked up by a forklift operated by a third person, who might drive to a storage area of the warehouse and drop the pallet for a fourth person to remove the individual boxes from the pallet and place them on shelves in a storage area. Some robotic solutions have been developed to automate many of these functions. Such robots may either be specialist robots (i.e., designed to perform a single task or a small number of related tasks) or generalist robots (i.e., designed to perform a wide variety of tasks). To date, both specialist and generalist warehouse robots have been associated with significant limitations.

For example, because a specialist robot may be designed to perform a single task (e.g., unloading boxes from a truck onto a conveyor belt), while such specialized robots may be efficient at performing their designated task, they may be unable to perform other related tasks. As a result, either a person or a separate robot (e.g., another specialist robot designed for a different task) may be needed to perform the next task(s) in the sequence. As such, a warehouse may need to invest in multiple specialized robots to perform a sequence of tasks, or may need to rely on a hybrid operation in which there are frequent robot-to-human or human-to-robot handoffs of objects.

In contrast, while a generalist robot may be designed to perform a wide variety of tasks (e.g., unloading, palletizing, transporting, depalletizing, and/or storing), such generalist robots may be unable to perform individual tasks with high enough efficiency or accuracy to warrant introduction into a highly streamlined warehouse operation. For example, while mounting an off-the-shelf robotic manipulator onto an off-the-shelf mobile robot might yield a system that could, in theory, accomplish many warehouse tasks, such a loosely integrated system may be incapable of performing complex or dynamic motions that require coordination between the manipulator and the mobile base, resulting in a combined system that is inefficient and inflexible.

Typical operation of such a system within a warehouse environment may include the mobile base and the manipulator operating sequentially and (partially or entirely) independently of each other. For example, the mobile base may first drive toward a stack of boxes with the manipulator powered down. Upon reaching the stack of boxes, the mobile base may come to a stop, and the manipulator may power up and begin manipulating the boxes as the base remains stationary. After the manipulation task is completed, the manipulator may again power down, and the mobile base may drive to another destination to perform the next task.

In such systems, the mobile base and the manipulator may be regarded as effectively two separate robots that have been joined together. Accordingly, a controller associated with the manipulator may not be configured to share information with, pass commands to, or receive commands from a separate controller associated with the mobile base. As such, such a poorly integrated mobile manipulator robot may be forced to operate both its manipulator and its base at suboptimal speeds or through suboptimal trajectories, as the two separate controllers struggle to work together. Additionally, while certain limitations arise from an engineering perspective, additional limitations must be imposed to comply with safety regulations. For example, if a safety regulation requires that a mobile manipulator must be able to be completely shut down within a certain period of time when a human enters a region within a certain distance of the robot, a loosely integrated mobile manipulator robot may not be able to act sufficiently quickly to ensure that both the manipulator and the mobile base (individually and in aggregate) do not threaten the human. To ensure that such loosely integrated systems operate within required safety constraints, such systems are forced to operate at even slower speeds or to execute even more conservative trajectories than those limited speeds and trajectories as already imposed by the engineering problem. As such, the speed and efficiency of generalist robots performing tasks in warehouse environments to date have been limited.

In view of the above, a highly integrated mobile manipulator robot with system-level mechanical design and holistic control strategies between the manipulator and the mobile base may provide certain benefits in warehouse and/or logistics operations. Such an integrated mobile manipulator robot may be able to perform complex and/or dynamic motions that are unable to be achieved by conventional, loosely integrated mobile manipulator systems. As a result, this type of robot may be well suited to perform a variety of different tasks (e.g., within a warehouse environment) with speed, agility, and efficiency.

### Example Robot Overview

In this section, an overview of some components of one embodiment of a highly integrated mobile manipulator robot configured to perform a variety of tasks is provided to explain the interactions and interdependencies of various subsystems of the robot. Each of the various subsystems, as well as control strategies for operating the subsystems, are described in further detail in the following sections.

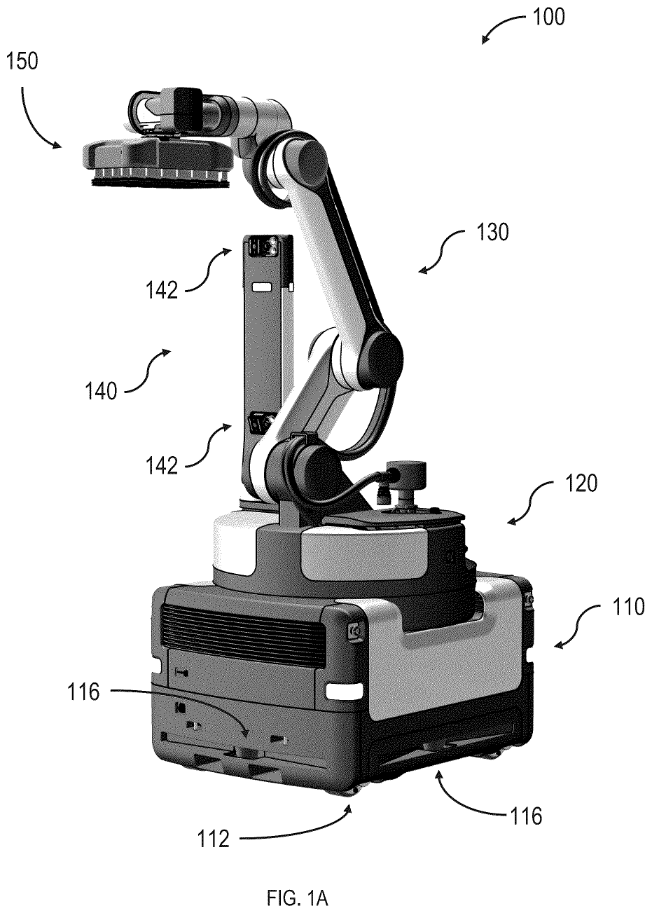

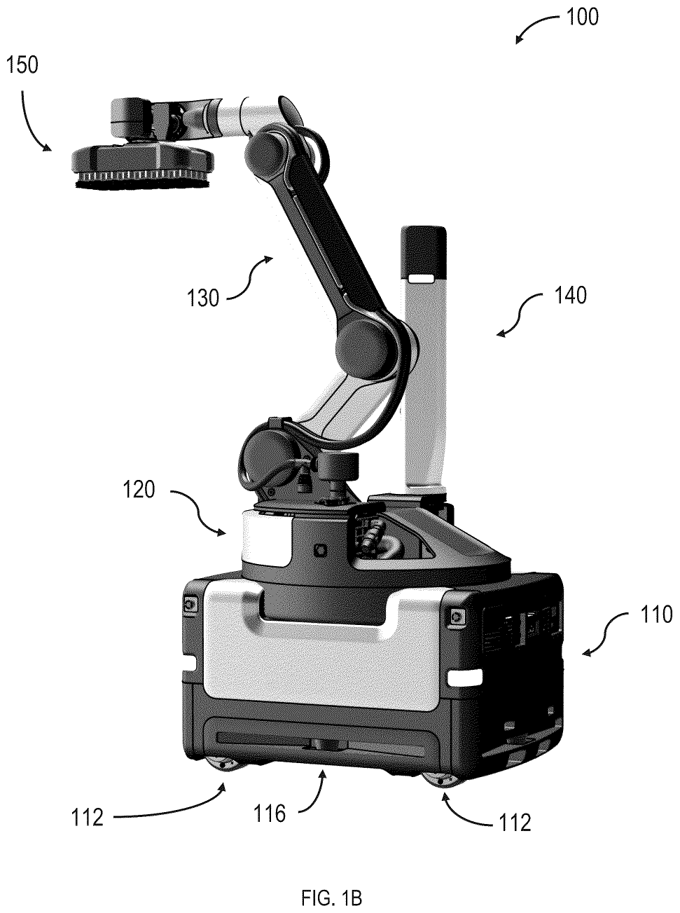

FIGS. 1A and 1B are perspective views of a robot 100, according to an illustrative embodiment of the invention. The robot 100 includes a mobile base 110 and a robotic arm 130. The mobile base 110 includes an omnidirectional drive system that enables the mobile base to translate in any direction within a horizontal plane as well as rotate about a vertical axis perpendicular to the plane. Each wheel 112 of the mobile base 110 is independently steerable and independently drivable. The mobile base 110 additionally includes a number of distance sensors 116 that assist the robot 100 in safely moving about its environment. The robotic arm 130 is a 6 degree of freedom (6-DOF) robotic arm including three pitch joints and a 3-DOF wrist. An end effector 150 is disposed at the distal end of the robotic arm 130. The robotic arm 130 is operatively coupled to the mobile base 110 via a turntable 120, which is configured to rotate relative to the mobile base 110. In addition to the robotic arm 130, a perception mast 140 is also coupled to the turntable 120, such that rotation of the turntable 120 relative to the mobile base 110 rotates both the robotic arm 130 and the perception mast 140. The robotic arm 130 is kinematically constrained to avoid collision with the perception mast 140. The perception mast 140 is additionally configured to rotate relative to the turntable 120, and includes a number of perception modules 142 configured to gather information about one or more objects in the robot's environment. The integrated structure and system-level design of the robot 100 enable fast and efficient operation in a number of different applications, some of which are provided below as examples.

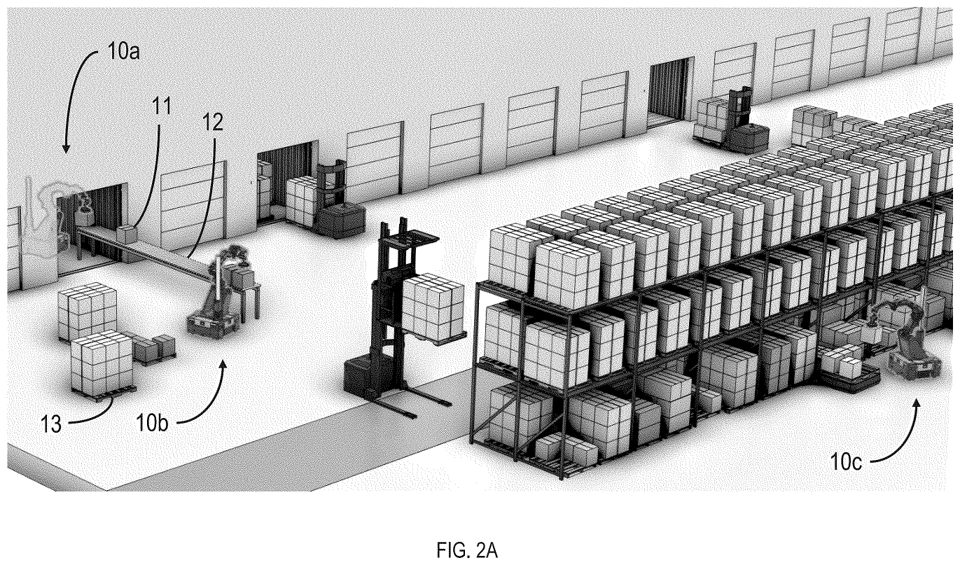

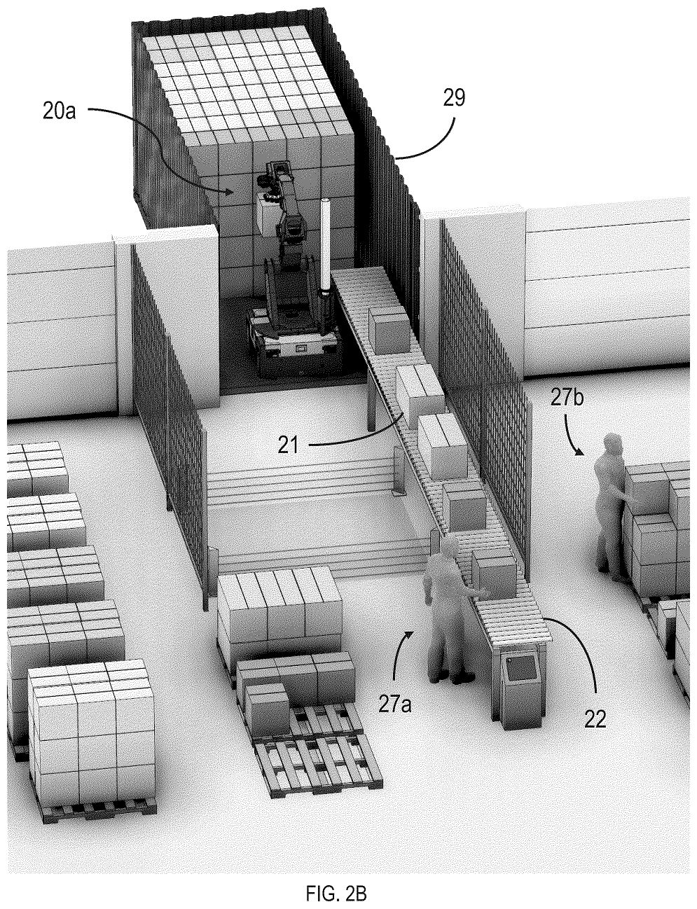

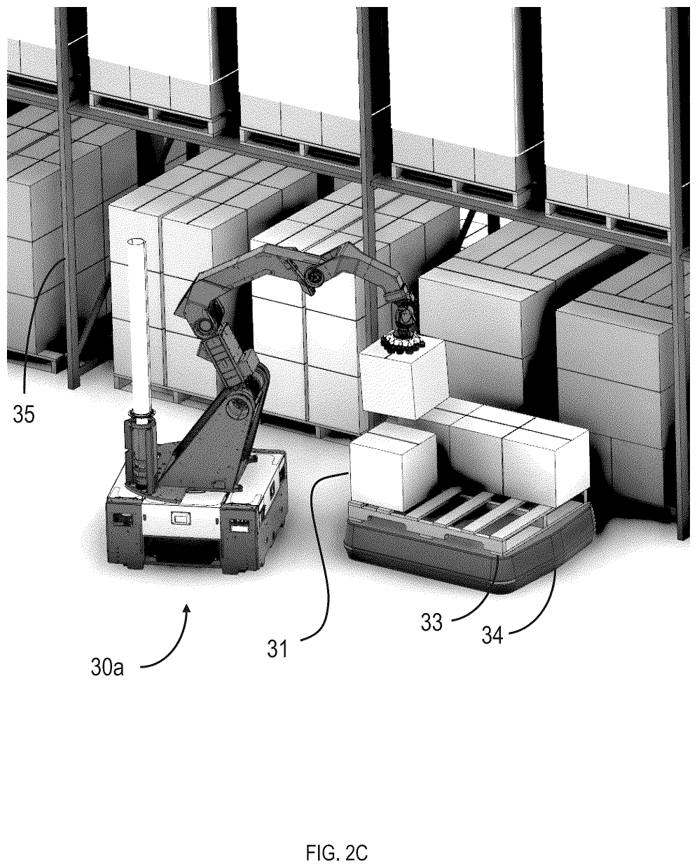

FIG. 2A depicts robots 10a, 10b, and 10c performing different tasks within a warehouse environment. A first robot 10a is inside a truck (or a container), moving boxes 11 from a stack within the truck onto a conveyor belt 12 (this particular task will be discussed in greater detail below in reference to FIG. 2B). At the opposite end of the conveyor belt 12, a second robot 10b organizes the boxes 11 onto a pallet 13. In a separate area of the warehouse, a third robot 10c picks boxes from shelving to build an order on a pallet (this particular task will be discussed in greater detail below in reference to FIG. 2C). The robots 10a, 10b, and 10c can be different instances of the same robot or similar robots. Accordingly, the robots described herein may be understood as specialized multi-purpose robots, in that they are designed to perform specific tasks accurately and efficiently, but are not limited to only one or a small number of tasks.

FIG. 2B depicts a robot 20a unloading boxes 21 from a truck 29 and placing them on a conveyor belt 22. In this box picking application (as well as in other box picking applications), the robot 20a repetitiously picks a box, rotates, places the box, and rotates back to pick the next box. Although robot 20a of FIG. 2B is a different embodiment from robot 100 of FIGS. 1A and 1B, referring to the components of robot 100 identified in FIGS. 1A and 1B will ease explanation of the operation of the robot 20a in FIG. 2B.

During operation, the perception mast of robot 20a (analogous to the perception mast 140 of robot 100 of FIGS. 1A and 1B) may be configured to rotate independently of rotation of the turntable (analogous to the turntable 120) on which it is mounted to enable the perception modules (akin to perception modules 142) mounted on the perception mast to capture images of the environment that enable the robot 20a to plan its next movement while simultaneously executing a current movement. For example, while the robot 20a is picking a first box from the stack of boxes in the truck 29, the perception modules on the perception mast may point at and gather information about the location where the first box is to be placed (e.g., the conveyor belt 22). Then, after the turntable rotates and while the robot 20a is placing the first box on the conveyor belt, the perception mast may rotate (relative to the turntable) such that the perception modules on the perception mast point at the stack of boxes and gather information about the stack of boxes, which is used to determine the second box to be picked. As the turntable rotates back to allow the robot to pick the second box, the perception mast may gather updated information about the area surrounding the conveyor belt. In this way, the robot 20a may parallelize tasks which may otherwise have been performed sequentially, thus enabling faster and more efficient operation.

Also of note in FIG. 2B is that the robot 20a is working alongside humans (e.g., workers 27a and 27b). Given that the robot 20a is configured to perform many tasks that have traditionally been performed by humans, the robot 20a is designed to have a small footprint, both to enable access to areas designed to be accessed by humans, and to minimize the size of a safety field around the robot (e.g., into which humans are prevented from entering and/or which are associated with other safety controls, as explained in greater detail below).

FIG. 2C depicts a robot 30a performing an order building task, in which the robot 30a places boxes 31 onto a pallet 33. In FIG. 2C, the pallet 33 is disposed on top of an autonomous mobile robot (AMR) 34, but it should be appreciated that the capabilities of the robot 30a described in this example apply to building pallets not associated with an AMR. In this task, the robot 30a picks boxes 31 disposed above, below, or within shelving 35 of the warehouse and places the boxes on the pallet 33. Certain box positions and orientations relative to the shelving may suggest different box picking strategies. For example, a box located on a low shelf may simply be picked by the robot by grasping a top surface of the box with the end effector of the robotic arm (thereby executing a “top pick”). However, if the box to be picked is on top of a stack of boxes, and there is limited clearance between the top of the box and the bottom of a horizontal divider of the shelving, the robot may opt to pick the box by grasping a side surface (thereby executing a “face pick”).

To pick some boxes within a constrained environment, the robot may need to carefully adjust the orientation of its arm to avoid contacting other boxes or the surrounding shelving. For example, in a typical “keyhole problem”, the robot may only be able to access a target box by navigating its arm through a small space or confined area (akin to a keyhole) defined by other boxes or the surrounding shelving. In such scenarios, coordination between the mobile base and the arm of the robot may be beneficial. For instance, being able to translate the base in any direction allows the robot to position itself as close as possible to the shelving, effectively extending the length of its arm (compared to conventional robots without omnidirectional drive which may be unable to navigate arbitrarily close to the shelving). Additionally, being able to translate the base backwards allows the robot to withdraw its arm from the shelving after picking the box without having to adjust joint angles (or minimizing the degree to which joint angles are adjusted), thereby enabling a simple solution to many keyhole problems.

The tasks depicted in FIGS. 2A-2C are only a few examples of applications in which an integrated mobile manipulator robot may be used, and the present disclosure is not limited to robots configured to perform only these specific tasks. For example, the robots described herein may be suited to perform tasks including, but not limited to: removing objects from a truck or container; placing objects on a conveyor belt; removing objects from a conveyor belt; organizing objects into a stack; organizing objects on a pallet; placing objects on a shelf; organizing objects on a shelf; removing objects from a shelf; picking objects from the top (e.g., performing a “top pick”); picking objects from a side (e.g., performing a “face pick”); coordinating with other mobile manipulator robots; coordinating with other warehouse robots (e.g., coordinating with AMRs); coordinating with humans; and many other tasks.

### Example Robotic Arm

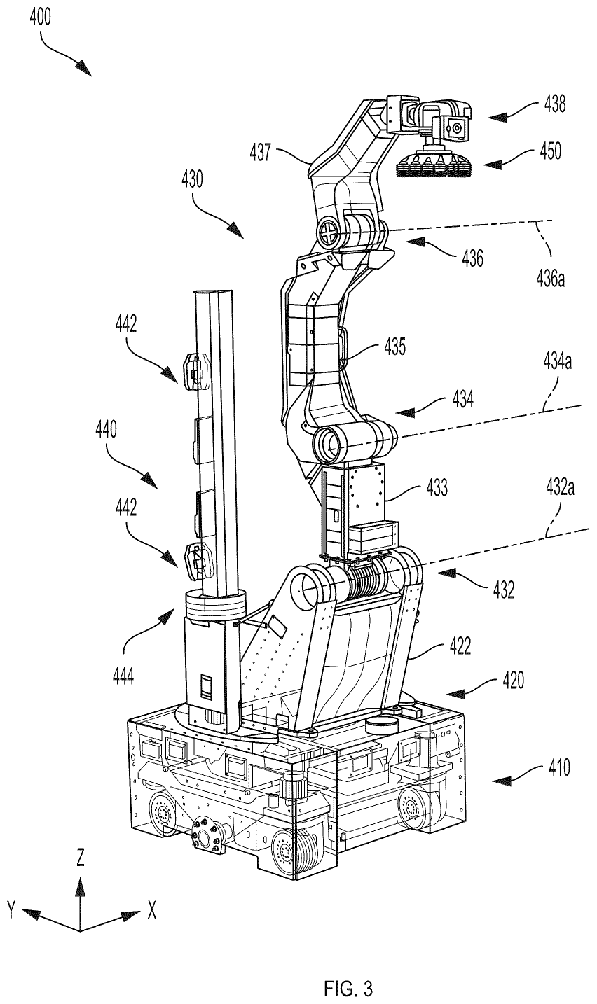

FIG. 3 is a perspective view of a robot 400, according to an illustrative embodiment of the invention. The robot 400 includes a mobile base 410 and a turntable 420 rotatably coupled to the mobile base. A robotic arm 430 is operatively coupled to the turntable 420, as is a perception mast 440. The perception mast 440 includes an actuator 444 configured to enable rotation of the perception mast 440 relative to the turntable 420 and/or the mobile base 410, so that a direction of the perception modules 442 of the perception mast may be independently controlled.

The robotic arm 430 of FIG. 3 is a 6-DOF robotic arm. When considered in conjunction with the turntable 420 (which is configured to yaw relative to the mobile base about a vertical axis parallel to the Z axis), the arm/turntable system may be considered a 7-DOF system. The 6-DOF robotic arm 430 includes three pitch joints 432, 434, and 436, and a 3-DOF wrist 438 which, in some embodiments, may be a spherical 3-DOF wrist.

Starting at the turntable 420, the robotic arm 430 includes a turntable offset 422, which is fixed relative to the turntable 420. A distal portion of the turntable offset 422 is rotatably coupled to a proximal portion of a first link 433 at a first joint 432. A distal portion of the first link 433 is rotatably coupled to a proximal portion of a second link 435 at a second joint 434. A distal portion of the second link 435 is rotatably coupled to a proximal portion of a third link 437 at a third joint 436. The first, second, and third joints 432, 434, and 436 are associated with first, second, and third axes 432a, 434a, and 436a, respectively.

The first, second, and third joints 432, 434, and 436 are additionally associated with first, second, and third actuators (not labeled) which are configured to rotate a link about an axis. Generally, the nth actuator is configured to rotate the nth link about the nth axis associated with the nth joint. Specifically, the first actuator is configured to rotate the first link 433 about the first axis 432a associated with the first joint 432, the second actuator is configured to rotate the second link 435 about the second axis 434a associated with the second joint 434, and the third actuator is configured to rotate the third link 437 about the third axis 436a associated with the third joint 436. In the embodiment shown in FIG. 3, the first, second, and third axes 432a, 434a, and 436a are parallel (and, in this case, are all parallel to the X axis). In the embodiment shown in FIG. 3, the first, second, and third joints 432, 434, and 436 are all pitch joints.

In some embodiments, a robotic arm of a highly integrated mobile manipulator robot may include a different number of degrees of freedom than the robotic arms discussed above. Additionally, a robotic arm need not be limited to a robotic arm with three pitch joints and a 3-DOF wrist. A robotic arm of a highly integrated mobile manipulator robot may include any suitable number of joints of any suitable type, whether revolute or prismatic. Revolute joints need not be oriented as pitch joints, but rather may be pitch, roll, yaw, or any other suitable type of joint.

Returning to FIG. 3, the robotic arm 430 includes a wrist 438. As noted above, the wrist 438 is a 3-DOF wrist, and in some embodiments may be a spherical 3-DOF wrist. The wrist 438 is coupled to a distal portion of the third link 437. The wrist 438 includes three actuators configured to rotate an end effector 450 coupled to a distal portion of the wrist 438 about three mutually perpendicular axes. Specifically, the wrist may include a first wrist actuator configured to rotate the end effector relative to a distal link of the arm (e.g., the third link 437) about a first wrist axis, a second wrist actuator configured to rotate the end effector relative to the distal link about a second wrist axis, and a third wrist actuator configured to rotate the end effector relative to the distal link about a third wrist axis. The first, second, and third wrist axes may be mutually perpendicular. In embodiments in which the wrist is a spherical wrist, the first, second, and third wrist axes may intersect.

In some embodiments, an end effector may be associated with one or more sensors. For example, a force/torque sensor may measure forces and/or torques (e.g., wrenches) applied to the end effector. Alternatively or additionally, a sensor may measure wrenches applied to a wrist of the robotic arm by the end effector (and, for example, an object grasped by the end effector) as the object is manipulated. Signals from these (or other) sensors may be used during mass estimation and/or path planning operations. In some embodiments, sensors associated with an end effector may include an integrated force/torque sensor, such as a 6-axis force/torque sensor. In some embodiments, separate sensors (e.g., separate force and torque sensors) may be employed. Some embodiments may include only force sensors (e.g., uniaxial force sensors, or multi-axis force sensors), and some embodiments may include only torque sensors. In some embodiments, an end effector may be associated with a custom sensing arrangement. For example, one or more sensors (e.g., one or more uniaxial sensors) may be arranged to enable sensing of forces and/or torques along multiple axes. An end effector (or another portion of the robotic arm) may additionally include any appropriate number or configuration of cameras, distance sensors, pressure sensors, light sensors, or any other suitable sensors, whether related to sensing characteristics of the payload or otherwise, as the disclosure is not limited in this regard.

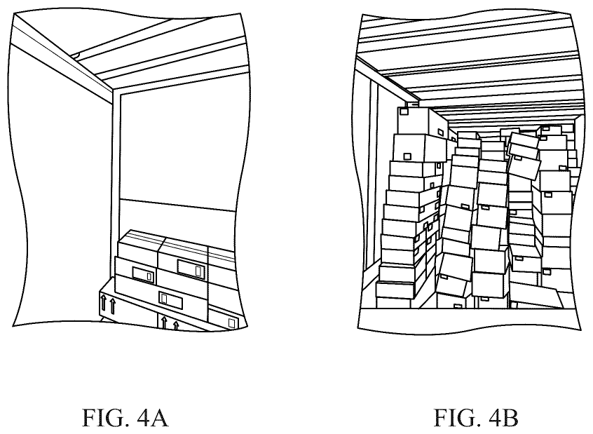

As discussed above, accurately measuring the location of a ceiling of a container, such as a truck cargo compartment, within which a mobile manipulator robot is working may be challenging with existing sensors on the robot (e.g., perception modules 142 located on perception mast 140 of robot 100 shown in FIG. 1A). FIGS. 4A and 4B illustrate two examples of images captured using a color camera (e.g., an RGB camera) mounted on a perception mast (e.g., perception mast 140 of robot 100 shown in FIG. 1A). As can be observed in the images of FIGS. 4A and 4B, although objects directly in front of or slightly above of the robot may be perceived reasonably well by the camera, objects above the height of the robot, such as the ceiling of the container, may not be represented well in the image, which makes estimation of the ceiling height challenging. Additionally, as shown in the images of FIGS. 4A and 4B, the ceiling of a container such as a truck, is often not a flat surface, but includes corrugations and/or crossbar supports to improve the stability of the container. The presence of such ceiling features additionally makes it challenging to accurately detect or model the ceiling of the container for collision avoidance during operation of the robot. As can also be appreciated from the images of FIGS. 4A and 4B, interior surfaces of a container, including the ceiling, may be highly reflective, which further complicates using camera images to determine ceiling characteristics. In an effort to address at least some of these challenges, some embodiments of the present disclosure relate to automated techniques for detecting a ceiling in a container using one or more distance sensors (e.g., direct time of flight sensors) arranged on an end effector (e.g., a gripper) of a mobile robot.

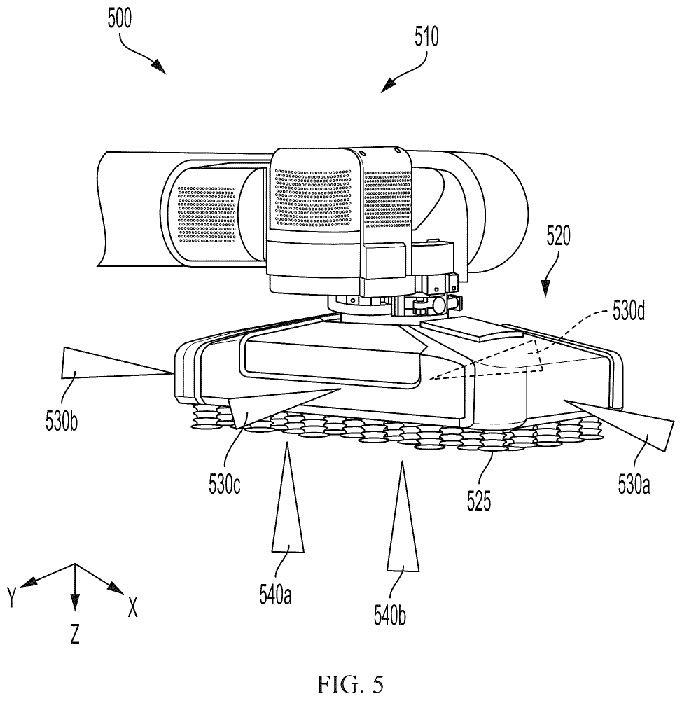

FIG. 5 illustrates an example of a robotic component 500 that include one or more distance sensors for detecting a ceiling of a container in accordance with some embodiments of the present disclosure. As shown, robotic component 500 corresponds to an end-effector portion of the robot and includes a wrist assembly 510 coupled to an arm of the robot, and a gripper 520 coupled to the wrist assembly 510. Gripper 520 may be configured as a vacuum-based gripper in which suction is applied through a plurality of suction cup assemblies 525 configured to grasp an object (e.g., a box) when suction is applied through them.

In the example of FIG. 5, the robotic component 500 includes a plurality of distance sensors arranged to detect a distance to objects in the environment of the robot in different directions. For instance, sensors 530a and 530b are arranged on opposite sides of gripper 520 and are configured to detect a distance to objects in the +/−X direction. Sensors 530c and 530d are arranged on opposite sides of gripper 520 and are configured to detect a distance to objects in the +/−Y direction. Sensors 540a and 540b are arranged in different locations on the cup assembly (gripping) surface and are configured to detect a distance to objects in the +Z direction (the suction direction). Although six distance sensors are shown, it should be appreciated that more or fewer distance sensors may alternatively be used. For instance, in some embodiments, only a single distance sensor (e.g., sensor 530a) may be included on gripper 520 for use in detecting a ceiling of a container. In other embodiments, two distance sensors (e.g., sensors 530a and 530b) located on opposite sides of gripper 520 may be used to detect a ceiling and/or a floor of a container. Having multiple distance sensors arranged on opposite sides of the gripper 520 enables simultaneous measurement of both the floor and the ceiling of the container, which may be useful, for example, for estimating a ceiling height for a container prior to the robot entering the container.

In some embodiments, distance sensors 530a-d and 540a-b are implemented as direct time-of-flight (TOF) sensors configured to detect signals reflected by an object located near (e.g., within 2 meters of) the robotic component 500. Other types of distance sensors including, but not limited to, acoustic-based (e.g., SONAR) distance sensors or laser-based distance sensors (e.g., laser range finders) may alternatively be used.

As described in more detail below, distance measurement signals sensed by the distance sensors arranged on the end effector of the robot may be provided to one or more computer processors. The one or more computer processors may be configured to process the distance measurement signals to detect one or more characteristics (e.g., distance, geometry) of a ceiling of a container within which the robot is operating or is intending to operate. The one or more characteristics of the ceiling of the container can then be used when determining how to operate the robot to perform a task, such as picking boxes from a stack of boxes within the container and placing them on a conveyor. For instance, the trajectory of the robotic arm and/or the end effector portion of the robotic arm may be selected in a way that avoids a collision with the ceiling of the container.

In some embodiments, the distance sensors 540a-b configured to detect objects in the Z direction (through the suction cup assemblies) may include a different type of distance sensors (or be configured differently) than the distance sensors 530a-d arranged on the sides of the gripper 520. For instance, distance sensors 540a-b being arranged on the suction cup assembly surface should have a transmit cone small enough to fit between the suction cup assemblies, whereas the distance sensors 530a-d may not have such restrictions. Accordingly, in some embodiments the distance sensors 530a-d are configured to have a larger field of view than the distance sensors 540a-b.

In some embodiments, locating distance sensors on a robotic component, such as an end effector that can be manipulated with dexterity enables for distance measurements to be made in ways that may not be possible with other sensors included in the perception system of the robot. For instance, the perception mast of the robot described in connection with FIGS. 1A and 1B is fixed to the base of the robot. By locating the distance sensors on the gripper of the robot, that portion of the robot may be inserted into an environment (e.g., a truck or other enclosure) prior to driving the entire robot into the enclosure (e.g., while the robot is located on a ramp leading into the truck). In this way, the distance sensors may provide a rough description of a container in which the robot plans to operate prior to entering the container.

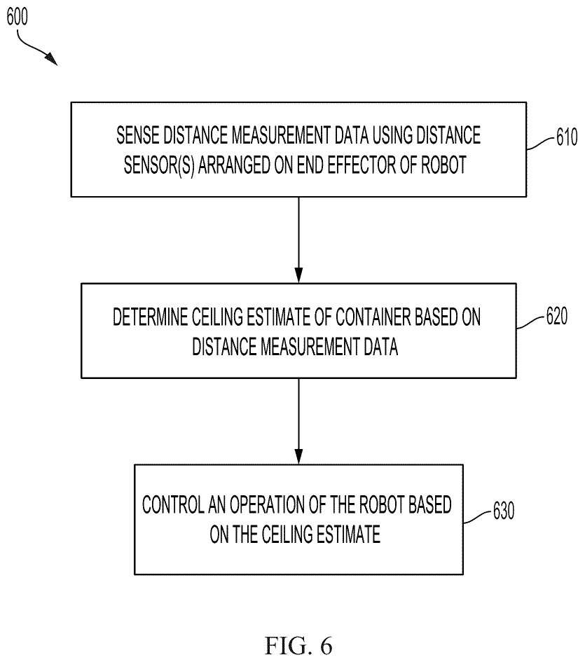

FIG. 6 is a flowchart of a process 600 for detecting a ceiling of a container in accordance with some embodiments of the present disclosure. In act 610, distance measurement data is sensed using one or more distance sensors arranged on an end effector of a robot. As described, one or more distance sensors (e.g. direct time-of-flight sensors) may be arranged on one or more sides of a gripper to enable the distance between the gripper and the ceiling of the container to be determined. In some embodiments, a single distance sensor oriented toward the ceiling of the container may be used to determine the ceiling height relative to the floor location, which is known due to the robot being located on the floor. In other embodiments, it may be beneficial to have at least two distance sensors arranged on opposite sides of the gripper to enable simultaneous measurement of both the floor distance to the gripper and the ceiling distance to the gripper. For example, the robot may extend its gripper into a container prior to entering it. Distance measurements of both the floor and the ceiling sensed by the distance sensors on opposite sides of the gripper may be used to determine the ceiling height of the container relative to the floor height. While it may be possible to perform the same measurement using a single distance sensor by rotating the gripper 180° about its rotation axis to measure the floor distance followed by the ceiling distance (or vice versa), such a measurement may take at least twice as long.

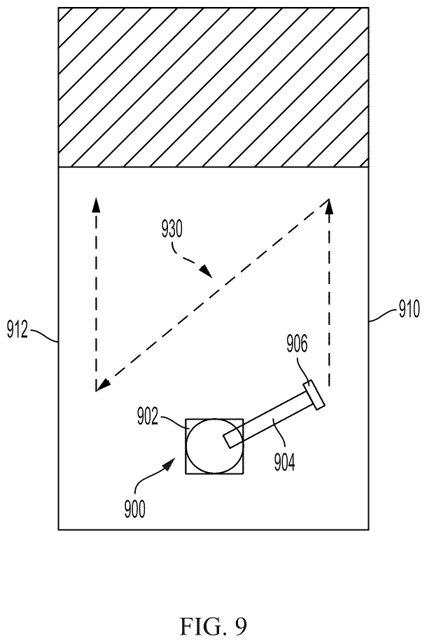

Process 600 then proceeds to act 620, where a ceiling estimate of the container is determined based, at least in part, on the distance measurement data. The ceiling estimate may include one or more characteristics of the ceiling, examples of which include, but are not limited to, ceiling height and ceiling geometry. For instance, the distance measurement data may include a point cloud of distance measurements sensed as the arm of the robot is moved through a scan trajectory. An example scan trajectory is described with reference to FIG. 9. A minimum distance may be determined from the point cloud of distance measurements and a plane representing the ceiling estimate may be fit at a height corresponding to the minimum distance. It should be appreciated that other types of ceiling estimates and/or techniques for determining ceiling estimates using the distance measurement data are also possible. For instance, some containers (e.g., shipping containers) may have standardized sizes. Some embodiments of the present disclosure may be configured to store a plurality of templates for different known sized containers, and the ceiling estimate for the container may be determined, at least in part, by matching the measured ceiling estimate to a template having a closest ceiling height.

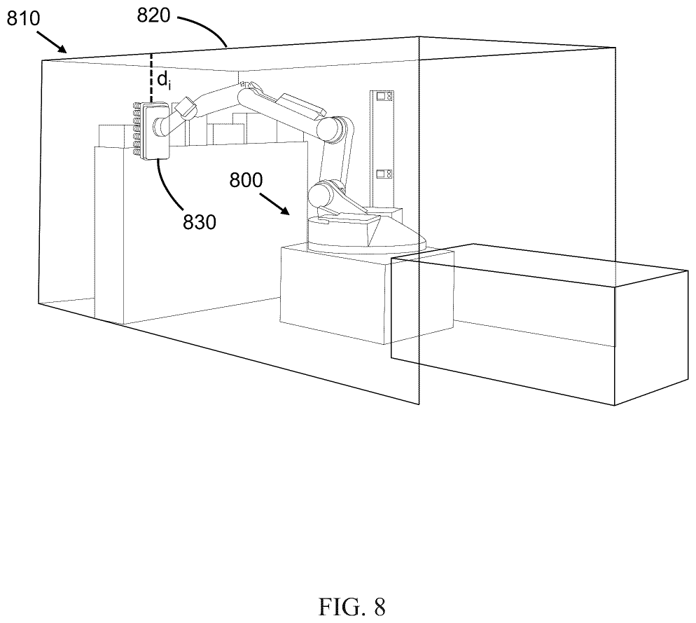

In some embodiments, distance measurement data may be sensed in act 610 and a ceiling estimate may be determined in act 620 only once, either prior to the robot entering the container or after the robot has entered the container, but prior to operation of the robot to interact with objects in the container. In other embodiments, distance measurement data may be periodically obtained (e.g., during the normal picking operation of the robot or at any other suitable time) when the end effector is oriented such that a distance measurement to the ceiling of the container can be sensed. For instance, the orientation of a gripper may be such that a distance sensor located on a top surface of the gripper when executing a face pick of an object (e.g., as shown in FIG. 8) is oriented in the direction of the ceiling of the container. In such a situation, the robot may be configured to obtain a distance measurement to the ceiling using the distance sensor. In some embodiments, when an object is detected above the estimated ceiling plane of a container, the robot may be configured to obtain a distance measurement to the ceiling using a distance sensor to ensure that the ceiling estimate is accurate. In such embodiments in which distance measurements are obtained during operation of the robot inside of the container, the ceiling estimate can be dynamically updated to, for example, account for the new distance measurement data, remove old distance measurement data, or may be updated in any other suitable way.

Process 600 then proceeds to act 630, where an operation of the robot is controlled based on the ceiling estimate. As described above, determining an accurate ceiling estimate using the techniques described herein enables the robot to operate in a safe manner that reduces the likelihood that the robot will collide with the ceiling of a container within which it is operating. Accordingly, the ceiling estimate may be taken into consideration as a part of a collision avoidance process when deciding on a trajectory to pick and/or place an object within the container. Additionally or alternatively, the ceiling estimate may be taken into consideration when considering how to grasp an object using its end effector. For instance, based on the location of an object to be grasped relative to the ceiling of the container, it may be determined to place the gripper at a location that reduces the likelihood of other objects (e.g., objects located below the object to be grasped) from tipping over, while ensuring that the grasp quality of the gripper is sufficient to grasp and move the object. As an example, rather the placing the gripper in the middle of a box such that a maximum number of suction cups engage the box, it may be determined that, when the box is close to the ceiling of the container, to offset the gripper relative to the center of the box such that fewer suction cups than the maximum possible number engage the box, while still maintaining a sufficient grasp on the box to move it. Other operations of the robot may additionally or alternatively be controlled based on the ceiling estimate in act 630, and embodiments of the present disclosure are not limited in this respect.

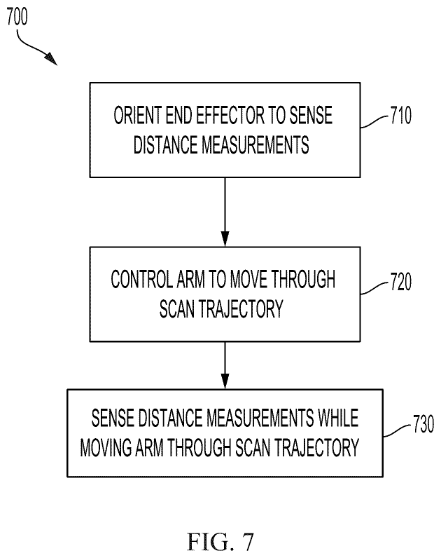

FIG. 7 is a flowchart of a process 700 for sensing distance measurements using one or more distance sensors arranged on an end effector of a mobile robot in accordance with some embodiments of the present disclosure. Process 700 begins in act 710, where the end effector is oriented such that a distance sensor arranged on the end effector that may be used to sense distance measurement is facing the ceiling of the container. In some embodiments in which each side of the end effector includes a distance sensor, an example of which is described in connection with FIG. 5, an explicit orientation step may not be needed as long as one of the sides of the end effector that includes a distance sensor is facing the ceiling. The distance sensor facing the ceiling may be activated for sensing distance measurements while the other distance sensors may be deactivated for sensing distance measurements. Alternatively, the other distance sensors not facing the ceiling may not be deactivated, but rather distance measurements from those sensors may simply be ignored when determining a ceiling estimate.

Process 700 then proceeds to act 720, where the arm of the robot is controlled to move through a scan trajectory in a plane parallel to the ceiling of the container. Process 700 then proceeds to act 730, where distance measurements are sensed by the distance sensors as the arm is moved through the scan trajectory. By moving the arm through the scan trajectory as distance measurements are sensed, a sampling of different points on the ceiling may be captured to help ensure that the distance measurements represent an accurate geometry of the ceiling of the container. For instance, capturing distance measurements at multiple points facilitates a determination of whether the ceiling of the container is flat, tapered (e.g., from back to front or front to back), bowed (e.g., taller in the middle of the container compared to the sides), or has some other geometry (e.g., crossbars extending across the width of the container).

FIG. 8 schematically illustrates a mobile robot 800 operating within a container 810 to pick boxes from a stack within the container and place the boxes on a conveyor that extends from within the container to outside the container. As shown in FIG. 8, mobile robot 800 includes a gripper 830 configured to grasp the boxes from the stack. Gripper 830 further includes at least one distance sensor configured to sense a distance di between the gripper and the ceiling 820 of the container 810.

FIG. 9 schematically illustrates a top view of a mobile robot 900 operating within a container having sides 910 and 912. Mobile robot 900 includes an arm 904 coupled to the base 902 of the robot 900 and an end effector 906 (e.g., a gripper) coupled to the arm 904. One or more distance sensors (not shown) are arranged on the end effector 906, and one of the distance sensors is oriented to face toward the ceiling of the container. The dashed arrows in FIG. 9 illustrate an example scan trajectory 930 through which the arm 904 of the robot 900 may travel during sensing of the distance measurements to the ceiling.

The inventors have recognized and appreciated that it may be advantageous to design a scan trajectory that includes scanning in multiple directions to ensure that enough features of the ceiling are captured to facilitate an accurate modeling of the ceiling surface. For instance, if only a single line of distance measurements is captured along the width of the container, all of the measurements may fail to capture one or more crossbars hanging down from the ceiling of the container if not directly above the end effector when scanning. Accordingly, in some embodiments, the scan trajectory includes a first segment oriented in a first direction and a second segment oriented at an angle relative to the first segment. The example scan trajectory 930 shown in FIG. 9 includes first and third segments along the length dimension of the container and a second segment connecting the first and third segments along a diagonal. Such a “Z” shaped scan trajectory provides a sampling of distance points within a rectangle of space that may capture most salient features of the ceiling. In some embodiments, the size of the rectangle within the available space of the container for scanning may be maximized to ensure that as many relevant distance measurements as possible can be captured. Scan trajectories other than the scan trajectory 930 shown in FIG. 9 are also possible.

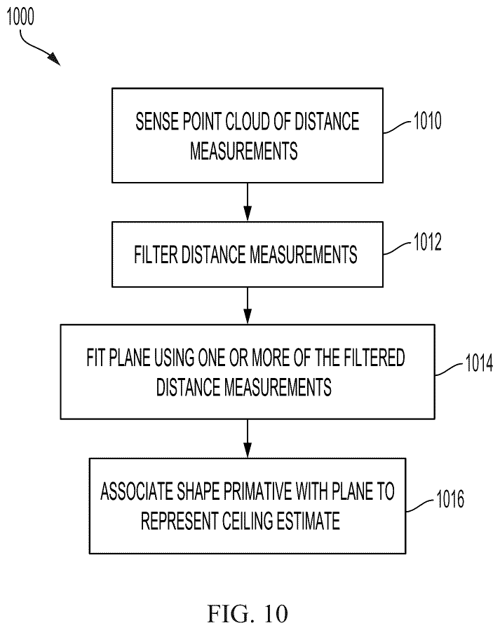

FIG. 10 is a flowchart of a process 1000 for determining a ceiling estimate based on sensed data measurements, in accordance with some embodiments of the present disclosure. Process 1000 begins in act 1010, where a point cloud of distance measurements is sensed using one or more of the techniques described herein. Process 1000 then proceeds to act 1012, where the distance measurements are filtered. The inventors have recognized and appreciated that at least some of the sensed distance measurements (e.g., measurements close to the distance sensor) may be attributable to “noise” rather than being an accurate representation of the ceiling height at the sensed location. For instance dust or other particles in the air may cause an aberrant distance measurement at one or a few locations during the scan trajectory. Accordingly, to remove contributions of such noise, at least some of the distance measurements may be ignored by filtering the sensed distance measurement data. The distance measurements may be filtered in any suitable way. For example, the distance measurements may be sorted and a certain proportion of the smallest distance measurements may be ignored (e.g., the smallest 2%, 5%, 10%, etc.) to account for noise in the distance measurements. The threshold used for filtering may be dynamically tuned based on performance of the robot within the container or any other suitable metric. Other techniques, including clustering techniques, identification of bimodal distributions in the sensed distance measurement data, etc., may alternatively be used to identify distance measurements that may correspond to noise rather than the ceiling of the container.

Process 1000 then proceeds to act 1014, where a plane representing the ceiling of the container is fit using one or more of the filtered distance measurements. In some embodiments, a plane may be fit using a minimum distance measurement in the filtered distance measurements. For example, when the data is sorted to remove measurements close to the sensor during filtering in act 1012, the remaining smallest distance measurement may be determined as the minimum distance measurement, and a plane parallel to the floor may be fit at the minimum distance measurement. Any suitable type of plane including, but not limited to, a flat plane, a curved plane, an angled plane, or multiple planes (e.g., if there is a step in the ceiling) may be fit using one or more of the filtered distance measurements. As one example, a flat plane parallel to the floor of the container may be fit at the level of the minimum distance as described above. In another example, an angled plane may be fit to the filtered distance measurements when the ceiling of the container is tapered from back to front or front to back. In such an example, multiple distance measurements along the length of the container's ceiling may be used to define the angled plane. In another example, a curved plane may be fit when the ceiling of the container is determined to be bowed in the middle. In such an example, multiple distance measurements along the width of the container may be used to fit the curved plane, to characterize the bowed ceiling of the container. Planes having other geometrical shapes are also possible. For instance, the plane may be both angled and curved. In some embodiments, more complex geometries including, but not limited to, the presence of crossbars coupled to the ceiling of the container may be modeled using the sensed distance measurements.

Process 1000 then proceeds to act 1016, where a shape primitive is associated with the plane to represent the ceiling estimate for the container. In some embodiments, a robot can use certain approximations (e.g., in determining candidate trajectories and/or conducting feasibility assessments) to help avoid collisions (e.g., between different portions of itself or with objects, such as the ceiling, in its surrounding environment). Such approximations are also referred to herein as “primitives” or “shape primitives,” and can be used to implement collision avoidance by limiting the distance between primitives (e.g., a primitive representing the gripper and a primitive representing the ceiling). The primitives can be simple geometric shapes (e.g., spheres, boxes, etc.) or more complicated geometric shapes. Separation vectors can be computed to determine distances between certain primitives of interest to provide quantifiable metrics to help ensure that collisions are avoided (e.g., by ensuring that the distances remain above a specified positive number). In some embodiments, two points (one on each primitive) that are closest together can be determined, and the vector connecting the two points can determine the corresponding separation vector.

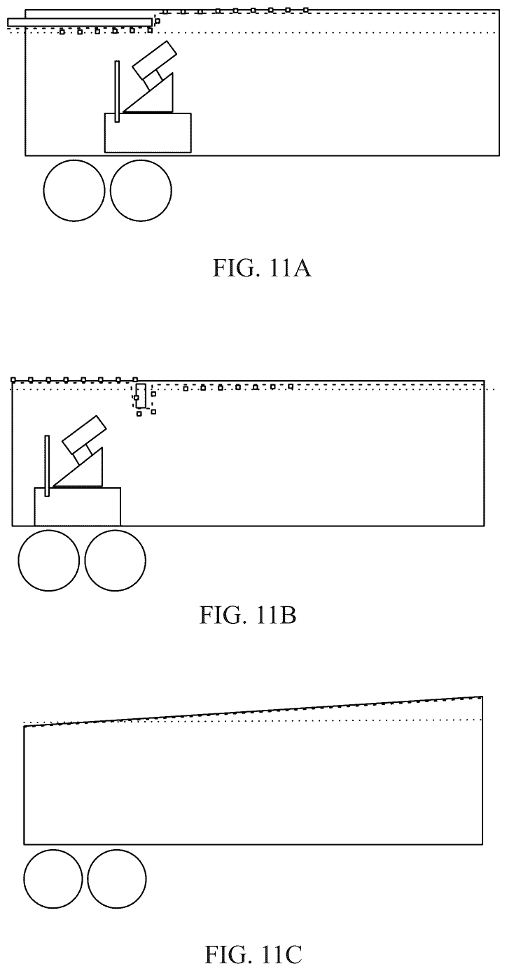

FIGS. 11A-11C illustrate example cross-sections of containers (truck cargo compartments) having non-flat ceilings in which performing automated ceiling detection in accordance with the techniques described herein may be helpful to characterize the ceiling of the container. In FIG. 11A, a door of the container slides up and into the container when opened, causing the ceiling height to be restricted close to the door opening of the container. On the one hand, failure to model the reduced ceiling height due to the presence of the door within the container may cause collisions with the robot when in operation within the container. On the other hand, failure to recognize that the door only extends partway into the container such that the ceiling is higher at the point where the door ends may unnecessarily limit the workspace of the robot if the plane is drawn with respect to the bottom of the door as shown with the solid line in FIG. 11A. A consequence of conservatively modeling the ceiling plane to avoid collisions may be that objects (e.g., boxes) located near the ceiling may not be able to be picked effectively by the robot since they may appear to the robot as being located above the estimated ceiling plane of the container. Accordingly, some embodiments may model the ceiling using multiple planes (dotted line in FIG. 11A) to account for the change in ceiling height along the length of the container.

In FIG. 11B, the container includes a crossbar arranged between the two sides of the container. Failure to model the crossbar may result in collisions with the crossbar if the ceiling plane is fit to the higher part of the ceiling where the crossbar does not exist (solid line in FIG. 11B). By contrast, fitting a plane to the lowest point on the crossbar may restrict the workspace of the robot, similar to the scenario discussed in FIG. 11A. As with the scenario in FIG. 11A, multiple planes (dotted line in FIG. 11B) may be fit to account for the complex geometry in FIG. 11B such that the crossbar is represented in the ceiling estimate but does not restrict the workspace of the robot more than what is necessary to avoid collisions with the ceiling.

FIG. 11C illustrates a scenario in which the ceiling of the container is pitched up from back to front. In such a scenario, fitting a plane parallel to the floor of the container (solid line in FIG. 11C) at the minimum sensed distance measurement may restrict the workspace of the robot, such that objects placed above the solid line in the example of FIG. 11C may not be grasped by the robot during object selection. To account for the sloped ceiling of the container, an angled plane (dotted line in FIG. 11C) may be fit between the minimum distance point near the back of the container and another distance measurement point near the front of the container, as shown.

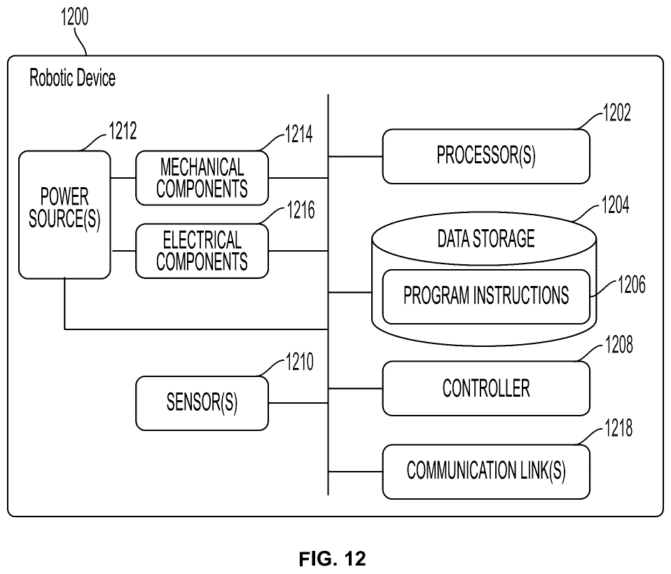

FIG. 12 illustrates an example configuration of a robotic device 1200, according to an illustrative embodiment of the invention. An example implementation involves a robotic device configured with at least one robotic limb, one or more sensors, and a processing system. The robotic limb may be an articulated robotic appendage including a number of members connected by joints. The robotic limb may also include a number of actuators (e.g., 2-5 actuators) coupled to the members of the limb that facilitate movement of the robotic limb through a range of motion limited by the joints connecting the members. The sensors may be configured to measure properties of the robotic device, such as angles of the joints, pressures within the actuators, joint torques, and/or positions, velocities, and/or accelerations of members of the robotic limb(s) at a given point in time. The sensors may also be configured to measure an orientation (e.g., a body orientation measurement) of the body of the robotic device (which may also be referred to herein as the “base” of the robotic device). Other example properties include the masses of various components of the robotic device, among other properties. The processing system of the robotic device may determine the angles of the joints of the robotic limb, either directly from angle sensor information or indirectly from other sensor information from which the joint angles can be calculated. The processing system may then estimate an orientation of the robotic device based on the sensed orientation of the base of the robotic device and the joint angles.

An orientation may herein refer to an angular position of an object. In some instances, an orientation may refer to an amount of rotation (e.g., in degrees or radians) about three axes. In some cases, an orientation of a robotic device may refer to the orientation of the robotic device with respect to a particular reference frame, such as the ground or a surface on which it stands. An orientation may describe the angular position using Euler angles, Tait-Bryan angles (also known as yaw, pitch, and roll angles), and/or Quaternions. In some instances, such as on a computer-readable medium, the orientation may be represented by an orientation matrix and/or an orientation quaternion, among other representations.

In some scenarios, measurements from sensors on the base of the robotic device may indicate that the robotic device is oriented in such a way and/or has a linear and/or angular velocity that requires control of one or more of the articulated appendages in order to maintain balance of the robotic device. In these scenarios, however, it may be the case that the limbs of the robotic device are oriented and/or moving such that balance control is not required. For example, the body of the robotic device may be tilted to the left, and sensors measuring the body's orientation may thus indicate a need to move limbs to balance the robotic device; however, one or more limbs of the robotic device may be extended to the right, causing the robotic device to be balanced despite the sensors on the base of the robotic device indicating otherwise. The limbs of a robotic device may apply a torque on the body of the robotic device and may also affect the robotic device's center of mass. Thus, orientation and angular velocity measurements of one portion of the robotic device may be an inaccurate representation of the orientation and angular velocity of the combination of the robotic device's body and limbs (which may be referred to herein as the “aggregate” orientation and angular velocity).

In some implementations, the processing system may be configured to estimate the aggregate orientation and/or angular velocity of the entire robotic device based on the sensed orientation of the base of the robotic device and the measured joint angles. The processing system has stored thereon a relationship between the joint angles of the robotic device and the extent to which the joint angles of the robotic device affect the orientation and/or angular velocity of the base of the robotic device. The relationship between the joint angles of the robotic device and the motion of the base of the robotic device may be determined based on the kinematics and mass properties of the limbs of the robotic devices. In other words, the relationship may specify the effects that the joint angles have on the aggregate orientation and/or angular velocity of the robotic device. Additionally, the processing system may be configured to determine components of the orientation and/or angular velocity of the robotic device caused by internal motion and components of the orientation and/or angular velocity of the robotic device caused by external motion. Further, the processing system may differentiate components of the aggregate orientation in order to determine the robotic device's aggregate yaw rate, pitch rate, and roll rate (which may be collectively referred to as the “aggregate angular velocity”).

In some implementations, the robotic device may also include a control system that is configured to control the robotic device on the basis of a simplified model of the robotic device. The control system may be configured to receive the estimated aggregate orientation and/or angular velocity of the robotic device, and subsequently control one or more jointed limbs of the robotic device to behave in a certain manner (e.g., maintain the balance of the robotic device).

In some implementations, the robotic device may include force sensors that measure or estimate the external forces (e.g., the force applied by a limb of the robotic device against the ground) along with kinematic sensors to measure the orientation of the limbs of the robotic device. The processing system may be configured to determine the robotic device's angular momentum based on information measured by the sensors. The control system may be configured with a feedback-based state observer that receives the measured angular momentum and the aggregate angular velocity, and provides a reduced-noise estimate of the angular momentum of the robotic device. The state observer may also receive measurements and/or estimates of torques or forces acting on the robotic device and use them, among other information, as a basis to determine the reduced-noise estimate of the angular momentum of the robotic device.

In some implementations, multiple relationships between the joint angles and their effect on the orientation and/or angular velocity of the base of the robotic device may be stored on the processing system. The processing system may select a particular relationship with which to determine the aggregate orientation and/or angular velocity based on the joint angles. For example, one relationship may be associated with a particular joint being between 0 and 90 degrees, and another relationship may be associated with the particular joint being between 91 and 180 degrees. The selected relationship may more accurately estimate the aggregate orientation of the robotic device than the other relationships.

In some implementations, the processing system may have stored thereon more than one relationship between the joint angles of the robotic device and the extent to which the joint angles of the robotic device affect the orientation and/or angular velocity of the base of the robotic device. Each relationship may correspond to one or more ranges of joint angle values (e.g., operating ranges). In some implementations, the robotic device may operate in one or more modes. A mode of operation may correspond to one or more of the joint angles being within a corresponding set of operating ranges. In these implementations, each mode of operation may correspond to a certain relationship.

The angular velocity of the robotic device may have multiple components describing the robotic device's orientation (e.g., rotational angles) along multiple planes. From the perspective of the robotic device, a rotational angle of the robotic device turned to the left or the right may be referred to herein as “yaw.” A rotational angle of the robotic device upwards or downwards may be referred to herein as “pitch.” A rotational angle of the robotic device tilted to the left or the right may be referred to herein as “roll.” Additionally, the rate of change of the yaw, pitch, and roll may be referred to herein as the “yaw rate,” the “pitch rate,” and the “roll rate,” respectively.

FIG. 12 illustrates an example configuration of a robotic device (or “robot”) 1200, according to an illustrative embodiment of the invention. The robotic device 1200 represents an example robotic device configured to perform the operations described herein. Additionally, the robotic device 1200 may be configured to operate autonomously, semi-autonomously, and/or using directions provided by user(s), and may exist in various forms, such as a humanoid robot, biped, quadruped, or other mobile robot, among other examples. Furthermore, the robotic device 1200 may also be referred to as a robotic system, mobile robot, or robot, among other designations.

As shown in FIG. 12, the robotic device 1200 includes processor(s) 1202, data storage 1204, program instructions 1206, controller 1208, sensor(s) 1210, power source(s) 1212, mechanical components 1214, and electrical components 1216. The robotic device 1200 is shown for illustration purposes and may include more or fewer components without departing from the scope of the disclosure herein. The various components of robotic device 1200 may be connected in any manner, including via electronic communication means, e.g., wired or wireless connections. Further, in some examples, components of the robotic device 1200 may be positioned on multiple distinct physical entities rather on a single physical entity. Other example illustrations of robotic device 1200 may exist as well.

Processor(s) 1202 may operate as one or more general-purpose processor or special purpose processors (e.g., digital signal processors, application specific integrated circuits, etc.). The processor(s) 1202 can be configured to execute computer-readable program instructions 1206 that are stored in the data storage 1204 and are executable to provide the operations of the robotic device 1200 described herein. For instance, the program instructions 1206 may be executable to provide operations of controller 1208, where the controller 1208 may be configured to cause activation and/or deactivation of the mechanical components 1214 and the electrical components 1216. The processor(s) 1202 may operate and enable the robotic device 1200 to perform various functions, including the functions described herein.

The data storage 1204 may exist as various types of storage media, such as a memory. For example, the data storage 1204 may include or take the form of one or more computer-readable storage media that can be read or accessed by processor(s) 1202. The one or more computer-readable storage media can include volatile and/or non-volatile storage components, such as optical, magnetic, organic or other memory or disc storage, which can be integrated in whole or in part with processor(s) 1202. In some implementations, the data storage 1204 can be implemented using a single physical device (e.g., one optical, magnetic, organic or other memory or disc storage unit), while in other implementations, the data storage 1204 can be implemented using two or more physical devices, which may communicate electronically (e.g., via wired or wireless communication). Further, in addition to the computer-readable program instructions 1206, the data storage 1204 may include additional data such as diagnostic data, among other possibilities.

The robotic device 1200 may include at least one controller 1208, which may interface with the robotic device 1200. The controller 1208 may serve as a link between portions of the robotic device 1200, such as a link between mechanical components 1214 and/or electrical components 1216. In some instances, the controller 1208 may serve as an interface between the robotic device 1200 and another computing device. Furthermore, the controller 1208 may serve as an interface between the robotic device 1200 and a user(s). The controller 1208 may include various components for communicating with the robotic device 1200, including one or more joysticks or buttons, among other features. The controller 1208 may perform other operations for the robotic device 1200 as well. Other examples of controllers may exist as well.

Additionally, the robotic device 1200 includes one or more sensor(s) 1210 such as force sensors, proximity sensors, motion sensors, load sensors, position sensors, touch sensors, depth sensors, ultrasonic range sensors, and/or infrared sensors, among other possibilities. The sensor(s) 1210 may provide sensor data to the processor(s) 1202 to allow for appropriate interaction of the robotic device 1200 with the environment as well as monitoring of operation of the systems of the robotic device 1200. The sensor data may be used in evaluation of various factors for activation and deactivation of mechanical components 1214 and electrical components 1216 by controller 1208 and/or a computing system of the robotic device 1200.

The sensor(s) 1210 may provide information indicative of the environment of the robotic device for the controller 1208 and/or computing system to use to determine operations for the robotic device 1200. For example, the sensor(s) 1210 may capture data corresponding to the terrain of the environment or location of nearby objects, which may assist with environment recognition and navigation, etc. In an example configuration, the robotic device 1200 may include a sensor system that may include a camera, RADAR, LIDAR, time-of-flight camera, global positioning system (GPS) transceiver, and/or other sensors for capturing information of the environment of the robotic device 1200. The sensor(s) 1210 may monitor the environment in real-time and detect obstacles, elements of the terrain, weather conditions, temperature, and/or other parameters of the environment for the robotic device 1200.

Further, the robotic device 1200 may include other sensor(s) 1210 configured to receive information indicative of the state of the robotic device 1200, including sensor(s) 1210 that may monitor the state of the various components of the robotic device 1200. The sensor(s) 1210 may measure activity of systems of the robotic device 1200 and receive information based on the operation of the various features of the robotic device 1200, such the operation of extendable legs, arms, or other mechanical and/or electrical features of the robotic device 1200. The sensor data provided by the sensors may enable the computing system of the robotic device 1200 to determine errors in operation as well as monitor overall functioning of components of the robotic device 1200.

For example, the computing system may use sensor data to determine the stability of the robotic device 1200 during operations as well as measurements related to power levels, communication activities, components that require repair, among other information. As an example configuration, the robotic device 1200 may include gyroscope(s), accelerometer(s), and/or other possible sensors to provide sensor data relating to the state of operation of the robotic device. Further, sensor(s) 1210 may also monitor the current state of a function that the robotic device 1200 may currently be operating. Additionally, the sensor(s) 1210 may measure a distance between a given robotic limb of a robotic device and a center of mass of the robotic device. Other example uses for the sensor(s) 1210 may exist as well.

Additionally, the robotic device 1200 may also include one or more power source(s) 1212 configured to supply power to various components of the robotic device 1200. Among possible power systems, the robotic device 1200 may include a hydraulic system, electrical system, batteries, and/or other types of power systems. As an example illustration, the robotic device 1200 may include one or more batteries configured to provide power to components via a wired and/or wireless connection. Within examples, components of the mechanical components 1214 and electrical components 1216 may each connect to a different power source or may be powered by the same power source. Components of the robotic device 1200 may connect to multiple power sources as well.

Within example configurations, any type of power source may be used to power the robotic device 1200, such as a gasoline and/or electric engine. Further, the power source(s) 1212 may charge using various types of charging, such as wired connections to an outside power source, wireless charging, combustion, or other examples. Other configurations may also be possible. Additionally, the robotic device 1200 may include a hydraulic system configured to provide power to the mechanical components 1214 using fluid power. Components of the robotic device 1200 may operate based on hydraulic fluid being transmitted throughout the hydraulic system to various hydraulic motors and hydraulic cylinders, for example. The hydraulic system of the robotic device 1200 may transfer a large amount of power through small tubes, flexible hoses, or other links between components of the robotic device 1200. Other power sources may be included within the robotic device 1200.

Mechanical components 1214 can represent hardware of the robotic device 1200 that may enable the robotic device 1200 to operate and perform physical functions. As a few examples, the robotic device 1200 may include actuator(s), extendable leg(s), arm(s), wheel(s), one or multiple structured bodies for housing the computing system or other components, and/or other mechanical components. The mechanical components 1214 may depend on the design of the robotic device 1200 and may also be based on the functions and/or tasks the robotic device 1200 may be configured to perform. As such, depending on the operation and functions of the robotic device 1200, different mechanical components 1214 may be available for the robotic device 1200 to utilize. In some examples, the robotic device 1200 may be configured to add and/or remove mechanical components 1214, which may involve assistance from a user and/or other robotic device.

The electrical components 1216 may include various components capable of processing, transferring, providing electrical charge or electric signals, for example. Among possible examples, the electrical components 1216 may include electrical wires, circuitry, and/or wireless communication transmitters and receivers to enable operations of the robotic device 1200. The electrical components 1216 may interwork with the mechanical components 1214 to enable the robotic device 1200 to perform various operations. The electrical components 1216 may be configured to provide power from the power source(s) 1212 to the various mechanical components 1214, for example. Further, the robotic device 1200 may include electric motors. Other examples of electrical components 1216 may exist as well.

In some implementations, the robotic device 1200 may also include communication link(s) 1218 configured to send and/or receive information. The communication link(s) 1218 may transmit data indicating the state of the various components of the robotic device 1200. For example, information read in by sensor(s) 1210 may be transmitted via the communication link(s) 1218 to a separate device. Other diagnostic information indicating the integrity or health of the power source(s) 1212, mechanical components 1214, electrical components 1216, processor(s) 1202, data storage 1204, and/or controller 1208 may be transmitted via the communication link(s) 1218 to an external communication device.

In some implementations, the robotic device 1200 may receive information at the communication link(s) 1218 that is processed by the processor(s) 1202. The received information may indicate data that is accessible by the processor(s) 1202 during execution of the program instructions 1206, for example. Further, the received information may change aspects of the controller 1208 that may affect the behavior of the mechanical components 1214 or the electrical components 1216. In some cases, the received information indicates a query requesting a particular piece of information (e.g., the operational state of one or more of the components of the robotic device 1200), and the processor(s) 1202 may subsequently transmit that particular piece of information back out the communication link(s) 1218.

In some cases, the communication link(s) 1218 include a wired connection. The robotic device 1200 may include one or more ports to interface the communication link(s) 1218 to an external device. The communication link(s) 1218 may include, in addition to or alternatively to the wired connection, a wireless connection. Some example wireless connections may utilize a cellular connection, such as CDMA, EVDO, GSM/GPRS, or 4G telecommunication, such as WiMAX or LTE. Alternatively or in addition, the wireless connection may utilize a Wi-Fi connection to transmit data to a wireless local area network (WLAN). In some implementations, the wireless connection may also communicate over an infrared link, radio, Bluetooth, or a near-field communication (NFC) device.

A number of implementations have been described. Nevertheless, it will be understood that various modifications may be made without departing from the spirit and scope of the disclosure.

1. A method of estimating a ceiling location of a container within which a mobile robot is configured to operate, the method comprising:
sensing distance measurement data associated with a ceiling of the container using one or more distance sensors arranged on an end effector of a mobile robot; and
determining a ceiling estimate of the container based on the distance measurement data.

2. The method of claim 1, wherein the one or more distance sensors include a first distance sensor arranged on a first side of the end effector, the first distance sensor being configured to sense a first distance in a first direction, the method further comprising:
orienting, prior to sensing the distance measurement data, the first distance sensor such that the first direction is toward the ceiling of the container.

3. The method of claim 2, wherein the one or more distance sensors include a second distance sensor arranged on a second side of the end effector, the second distance sensor being configured to sense a second distance in a second direction, the second direction being opposite the first direction,
wherein sensing distance measurement data comprises sensing distance measurement data including the first distance and the second distance.

4. The method of claim 2, wherein sensing distance measurement data comprises:
controlling an arm of the mobile robot to move the arm through a scan trajectory; and
sensing the distance measurement data as the arm is moved through the scan trajectory.

5. The method of claim 4, wherein controlling an arm of the mobile robot to move the arm through a scan trajectory comprises moving the arm through a scan trajectory that includes a first direction and a second direction at an angle to the first direction.

6. The method of claim 5, wherein the scan trajectory includes a first segment along the first direction, a second segment along the first direction, and a third segment along the second direction, the third segment connecting the first and second segments.

7. The method of claim 1, wherein sensing distance measurement data is performed while a base of the mobile robot is outside of the container.

8. The method of claim 1, wherein determining a ceiling estimate based on the distance measurement data comprises:
fitting a plane based on at least one datum in the distance measurement data; and
determining the ceiling estimate based on the plane.

9. The method of claim 8, wherein determining a ceiling estimate based on the distance measurement data further comprises:
determining the at least one datum as a datum having a minimum distance in the distance measurement data.

10. The method of claim 8, wherein determining a ceiling estimate based on the distance measurement data further comprises:
filtering the distance measurement data to generate filtered distance measurement data; and
determining the ceiling estimate based on the filtered distance measurement data.

11. The method of claim 10, wherein
filtering the distance measurement data comprises:
sorting the distance measurement data in order of distance to generate sorted data; and
excluding from the filtered distance measurement data, a threshold amount of the sorted data with a smallest distances.

12. The method of claim 8, wherein fitting a plane comprises fitting a flat plane to the at least one datum.

13. The method of claim 8, wherein fitting a plane comprises fitting a curved plane using at least two pieces of data of the distance measurement data.

14. The method of claim 8, wherein
determining a ceiling estimate based on the distance measurement data further comprises assigning a shape primitive to the plane, and
controlling at least one operation of the mobile robot based, at least in part, on the shape primitive.

15. The method of claim 1, further comprising:
controlling at least one operation of the mobile robot based on the ceiling estimate of the container.

16. The method of claim 15, wherein controlling at least one operation of the mobile robot based on the ceiling estimate of the container comprises:
determining a trajectory of an arm of the mobile robot based, at least in part, on the ceiling estimate; and
moving the arm in accordance with the trajectory.

17. The method of claim 15, wherein controlling at least one operation of the mobile robot based on the ceiling estimate of the container comprises:
determining a grasp strategy for grasping an object in the container based, at least in part, on the ceiling estimate; and
grasping the object using the grasp strategy.

18. The method of claim 15, wherein controlling at least one operation of the mobile robot based on the ceiling estimate of the container comprises controlling the mobile robot to move at least one component of the mobile robot without colliding with the ceiling of the container.

19. The method of claim 1, wherein the end effector comprises a suction-based gripper.

20. A mobile robot, comprising:
a mobile base;
an arm coupled to the mobile base;
a gripper coupled to the arm, wherein the gripper includes one or more distance sensors arranged thereon; and
a controller configured to:
determine a ceiling estimate of a container based on distance measurement data sensed by the one or more distance sensors.

21. A component of a mobile robot, the component comprising:
an arm configured to couple to a base of the mobile robot; and
an end effector coupled to the arm, the end effector including one or more distance sensors, wherein
the arm is configured to move through a scan trajectory,
the end effector is configured to orient a first distance sensor of the one or more distance sensors toward a ceiling of a container,
the first distance sensor is configured to capture first distance measurements as the arm is moved through the scan trajectory, and
a ceiling height of the container is determined based, at least in part, on the first distance measurements.
